(19) United States
(12) Patent Application Publication
(10) Pub. No.: US 2011/0107720 A1
(43) Pub. Date: May 12, 2011

(54) CARPET TILES AND CARPET TILE INSTALLATIONS

(75) Inventors: David D. Oakey, Atlanta, GA (US); Graham A.H. Scott, LaGrange, GA (US); John P. Bradford, LaGrange, GA (US); Keith N. Gray, Marietta, GA (US)

(73) Assignee: INTERFACE, INC., Atlanta, GA (US)

(21) Appl. No.: 12/814,654

(22) Filed: Jun. 14, 2010

Related U.S. Application Data
(63) Continuation-in-part of application No. 12/270,129, filed on Nov. 13, 2008.
Application No. 12/270,129 is a continuation of application No. 11/018,947, filed on Dec. 21, 2004, now Pat. No. 7,464,510.
Application No. 11/018,947 is a continuation-in-part of application No. 10/381,025, filed on Dec. 8, 2003, now abandoned.
Application No. 10/381,025 is a continuation-in-part of application No. 10/638,878, filed on Aug. 11, 2003, now abandoned.
(60) Provisional application No. 61/268,433, filed on Jun. 12, 2009.
(60) Provisional application No. 60/619,340, filed on Oct. 15, 2004.

(51) Int. Cl. E04B 5/00; B32B 3/02; B26D 3/00

(52) U.S. Cl. 52/746.1; 428/95; 428/80; 83/39

(57) ABSTRACT

Certain embodiments utilize carpet tiles of varying sizes and/or shapes that are connected together using connectors to form a carpet tile installation. In some instances, the carpet tiles used in the carpet tile installation have different colors, patterns, shapes, and/or styles. In some embodiments, carpet tiles of a standard size and shape, such as one-half square meter carpet tiles, are partitioned into carpet tile fractions. In certain embodiments, these carpet tile fractions are used in conjunction with larger carpet tiles in a carpet tile installation. In other embodiments, these carpet tile fractions may be connected to other carpet tile fractions to form a combination carpet tile that is then used in a carpet tile installation. Among other things, the use of different sized and/or shaped carpet tiles increases the randomness or diversity and/or improves other aspects of the appearance of the floor coverings formed by the carpet tile installations.

### RELATED APPLICATION DATA

The present application claims priority to U.S. Provisional Application No. 61/268,433, filed Jun. 12, 2009, entitled “CARPET TILES AND CARPET TILE INSTALLATIONS,” the contents of which are herein incorporated by reference. The present application is a continuation-in-part of U.S. Ser. No. 12/270,129, filed Nov. 13, 2008, entitled “SYSTEM AND METHOD FOR FLOOR COVERING INSTALLATION,” which is a continuation of Ser. No. 11/018,947, filed Dec. 21, 2004, now U.S. Pat. No. 7,464,510, entitled “SYSTEM AND METHOD FOR FLOOR COVERING INSTALLATION,” which claims priority to U.S. Provisional Application No. 60/619,340, filed Oct. 15, 2004, and is a continuation-in-part of U.S. Ser. Nos. 10/381,025 filed Dec. 8, 2003 and 10/638,878 filed Aug. 11, 2003, the contents of all of which are hereby incorporated by reference.

### FIELD OF THE INVENTION

Embodiments of this invention generally relate to carpet tiles and other textile face modular flooring and to methods of designing modular flooring tiles having patterns and configurations that provide various aesthetic and functional benefits.

### BACKGROUND

Conventional carpet tile has historically been a product that sought to mimic the appearance of broadloom carpet, which is continuous, and to hide or at least de-emphasize the fact that the product was modular. The imperative of a broadloom-like, continuous appearance long dictated that carpet tile styles be uniform in color and pattern within tiles and from one tile to another. For these reasons, carpet tiles in a carpet tile installation were conventionally of the same size and shape from one tile to another.

However, textile face modular flooring designers have recently begun to design flooring and flooring installations that do not seek to mask, but rather emphasize, the modularity of the flooring. Such carpet tiles are often installed “quarter-turned” with each tile position rotated 90° relative to each adjacent tile.

Traditionally, modules were often glued to the floor by first applying a layer of adhesive to the underlying flooring surface and then positioning the tiles on top of the adhesive. With this method, adhesive typically contacts the entire surface area of the underside of the flooring modules, which increases material costs and often leads to difficultly in re-positioning the tiles if they are positioned incorrectly. This is a particular problem during installation of patterned modules that must be matched at the seams. Moreover, when the modules are eventually removed, glue remains on the flooring surface and that glue sometimes retains portions of the removed tiles. The glue (and any flooring materials held by the glue) must be removed from the floor to create a smooth surface before installing new tiles. This adds both cost and time to the installation process.

As described in U.S. Pat. No. 7,464,510 (entitled “System and Method for Floor Covering Installation,” filed Dec. 21, 2004), which is incorporated herein in its entirety by this reference, connectors for joining adjacent modular floor covering units recently have been developed. Such connectors allow for the assembly of carpet tiles on an underlying floor surface without the need to attach them to the floor surface.

### SUMMARY

Embodiments of the invention provide carpet tiles of varying size and/or shape within a carpet tile installation and, in some instances, use carpet tiles of different color, pattern or style. In some embodiments, carpet tiles cut from a carpet web in a standard size and shape, such as one-half square meter carpet tiles, are partitioned into smaller carpet tile fractions. In certain embodiments, these carpet tile fractions are used in conjunction with larger carpet tiles in a carpet tile installation. In other embodiments, these carpet tile fractions are connected to other carpet tile fractions to form a combination carpet tile that is then used in a carpet tile installation. In some embodiments, this combination carpet tile is used with other carpet tiles in the carpet tile installation. In yet other embodiments, carpet tile fractions are cut directly from a carpet web and are used with other carpet tiles or with carpet tiles of a different size and/or shape, also cut from a carpet web, in a carpet tile installation.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different figures is intended to illustrate like or analogous components.

FIG. 1 is a perspective view of a carpet tile installation using larger square carpet tiles and smaller square carpet tiles according to one aspect of the invention.

FIG. 2 is a top plan view of the installation pattern used in FIG. 1.

FIG. 3A is a top plan view of an exemplary method of partitioning a larger square carpet tile into the smaller square carpet tiles used in the installation shown in FIG. 1.

FIG. 3B is a top plan view of the smaller square carpet tiles cut from the larger square carpet tile of FIG. 3A and used in the installation shown in FIG. 1.

FIG. 4 is perspective view of one embodiment of a connector and release layer according to one aspect of this invention.

FIG. 5A is a perspective view of a carpet tile installation using larger square carpet tiles and smaller carpet tile fractions according to one aspect of the invention.

FIG. 5B is a partial top plan view of the repeating pattern used to form the carpet tile installation illustrated in FIG. 5A.

FIG. 6A is a perspective view of a carpet tile installation using larger square carpet tiles and smaller carpet tile fractions according to another aspect of the invention.

FIG. 6B is a partial top plan view of the repeating pattern used to form the carpet tile installation illustrated in FIG. 6A.

FIGS. 7A-7B are top plan views illustrating a technique for cutting carpet tile fractions from carpet tiles and for connecting the carpet tile fractions to form a combination carpet tile used in the repeating pattern of FIG. 6B.

FIG. 8A is a perspective view of a carpet tile installation using larger square carpet tiles and smaller carpet tile fractions according to yet another aspect of the invention.

FIG. 8B is a partial top plan view of the repeating pattern used to form the carpet tile installation illustrated in FIG. 8A.

FIG. 8C is a top plan view illustrating a technique for cutting carpet tile fractions from carpet tiles for use in the repeating pattern of FIG. 8B.

FIG. 9A is a perspective view of a carpet tile installation using larger square carpet tiles and smaller carpet tile fractions according to still another aspect of the invention.

FIG. 9B is a partial top plan view of the repeating pattern used to form the carpet tile installation illustrated in FIG. 9A.

FIG. 9C is a top plan view illustrating a technique for cutting carpet tile fractions from carpet tiles for use in the repeating pattern of FIG. 9B.

### DETAILED DESCRIPTION

Certain embodiments of the invention utilize carpet tiles of varying size and/or shape within a carpet tile installation and, in some instances, use carpet tiles of different color, pattern or style. In some embodiments, carpet tiles of a standard size and shape, such as one-half square meter carpet tiles, are cut from a carpet web and partitioned into carpet tile fractions. In certain embodiments, these carpet tile fractions are used in conjunction with larger carpet tiles in a carpet tile installation. In other embodiments, these carpet tile fractions are connected to other carpet tile fractions to form a combination carpet tile that is then used in a carpet tile installation. In some embodiments, this combination carpet tile is used with other carpet tiles, or with carpet tiles of a different size and/or shape, in the carpet tile installation.

Among other things, the use of different sized carpet tiles increases the randomness or diversity and/or improves other aspects of the appearance of the carpet tile installations.

Carpet tiles of different sizes and/or shapes can be formed in a variety of ways. Commercial carpet tiles may be manufactured utilizing a number of techniques, but the substantial majority of such products are manufactured by tufting carpet yarns into a tufting primary using a tufting machine. The fabric produced by the tufting machine is usually about six feet or two meters wide, and that fabric is referred to here as a carpet tile “web.” After the web is produced, one or more secondary backing layers are bonded to its underside to provide stability, stiffness, weight and other desirable properties, and the backed web is then cut into tiles.

Tiles can be cut from the web to create carpet tiles of different sizes and/or shapes. Alternatively, tiles of a single size (such as standard one-half square meter carpet tiles) may be initially cut from the web and then some or all of those tiles may be subsequently cut to form smaller tiles, referred to here as carpet tile fractions, of one or more varying shapes and other dimensions.

As shown in the Figures, the carpet tile installations of certain embodiments of this invention utilize square carpet tiles of a standard size manufactured in conventional manufacturing processes. In some embodiments, these square tiles are then cut into smaller carpet tile fractions, including, among other possibilities, smaller rectangular, triangular and/or square tile pieces. This second cutting operation can occur immediately after manufacture at the manufacturing facility, or can occur in the field during the installation process.

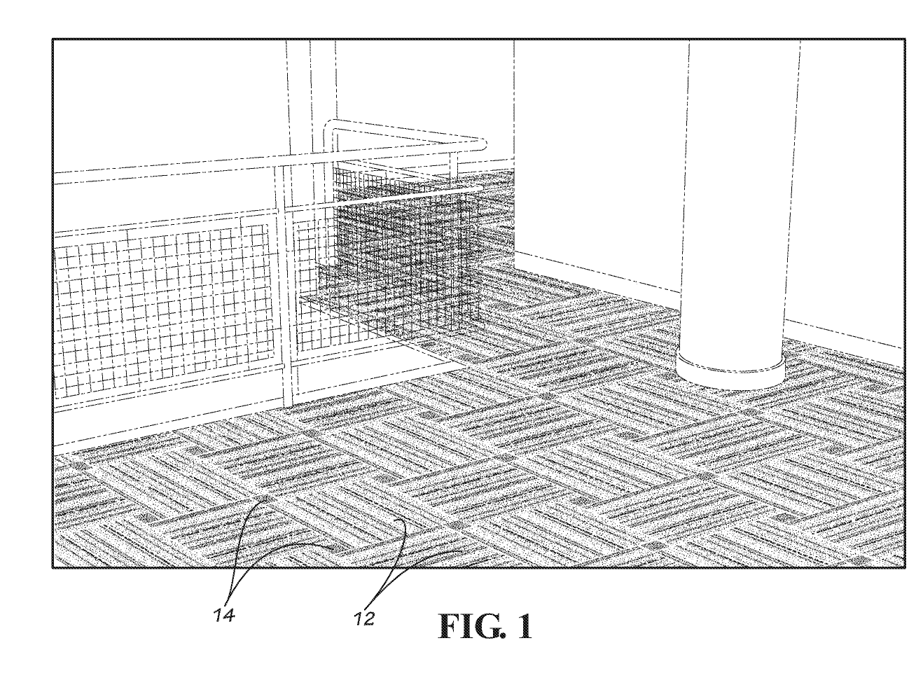

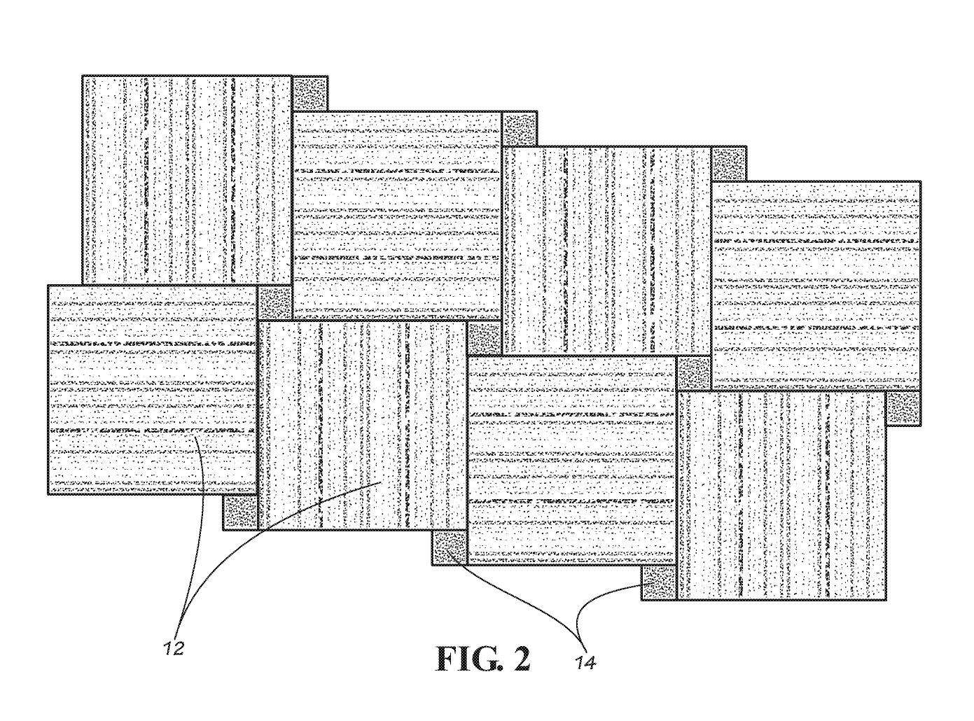

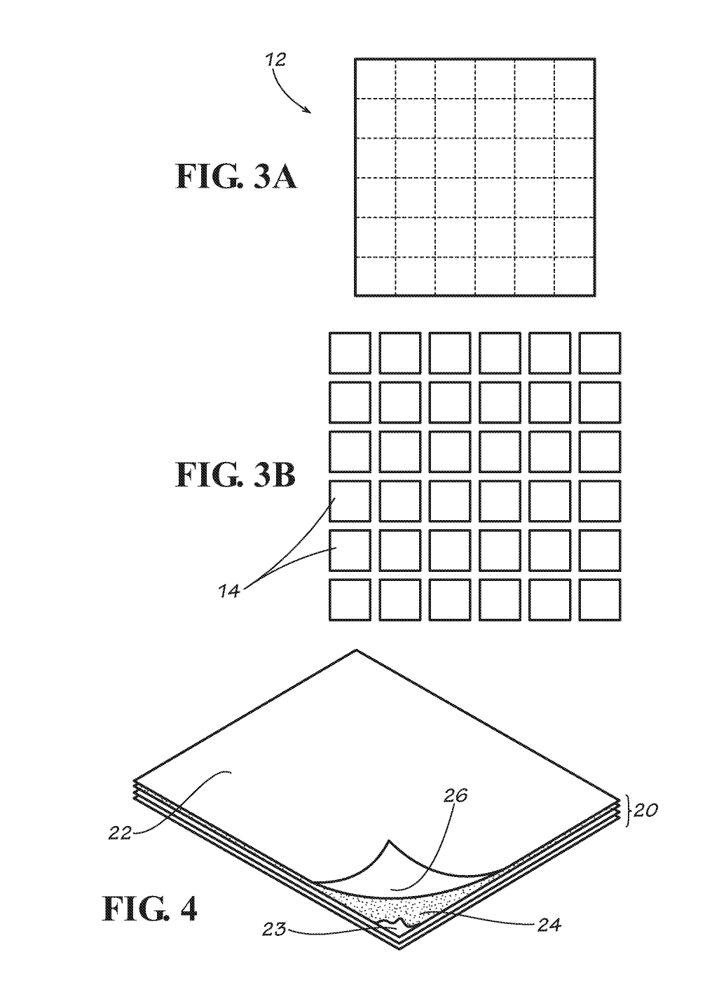

FIGS. 1-2 illustrates a carpet tile installation 10 comprised of larger square carpet tiles 12 and carpet tile fractions 14 that together form an exemplary installation pattern. In this embodiment, carpet tile fractions 14 are square carpet tiles that are smaller than larger square carpet tiles 12. While this particular installation pattern provides various aesthetic and other benefits, other installation patterns may be used. As shown in FIG. 3A, a larger square tile 12, such as a standard one-half square meter carpet tile, may be partitioned into carpet tile fractions and subsequently cut into carpet tile fractions 14, as shown in FIG. 3B. In other embodiments, carpet tile fractions 14 are cut directly from the carpet web without first being cut into the standard, larger square carpet tile 12.

The larger square carpet tiles 12 and carpet tile fractions 14 may be secured to the floor and/or one another using adhesive, tape, and/or various connectors, including, but not limited to, connectors such as those disclosed in U.S. Pat. No. 7,464,510 (entitled “System and Methods for Floor Covering Installation, filed Dec. 21, 2004), the entirety of which is incorporated herein by this reference.

In one embodiment, the carpet tile installation 10 illustrated in FIG. 1 comprises larger square carpet tiles 12 and carpet tile fractions 14 that are connected to one another using one or more connectors 20. As shown in FIG. 4, connector 20 includes a film 22 and an adhesive layer 24 coated on one side of the film 22. An optional release layer 26 is placed on top of the adhesive layer 24 to protect the underlying adhesive. In use, the release layer 26 is removed from the connector 20 to expose the adhesive layer 24.

The film 22 may be of any suitable material, but, to facilitate rapid flooring installations in accordance with this invention, is preferably made of a material that is relatively stiff so that a connector 20 positioned partly in contact with the underside of a tile will project beyond the edge of the tile in roughly the same plane as the underside of the tile. This facilitates proper positioning of the projecting connector portion to make appropriate contact with an adjacent tile. This is typically greater stiffness than most adhesive tapes that will significantly curl or droop down from an underside of a tile to which a portion (but not all) of a length of such adhesive tape is attached. At the same time, the film 22 from which connectors of this invention are made should be sufficiently flexible to facilitate handling the connectors in a roll if desired and to permit the connectors to conform to floor or tile irregularities.

The film 22 should also resist shrinkage, which can result in buckling of adjacent tiles, and exhibit a relatively high tensile strength to resist stretching under foot traffic and rolling loads. For example, materials that exhibit a tensile strength between 160-270 mega Pascals (“MPa”) in the machine direction and 165-210 MPa in the cross-machine direction have been found particularly suitable for this application. Moreover, the percentage by which the material may be elongated or stretched before breaking should also be relatively high to prevent connector breakage and failure when subjected to tensile stresses. For example, it is preferable, but not required, that the material used be capable of being stretched 120-200% of its machine direction dimension and 150-170% of its cross-machine direction dimension before breaking.

The connector 20 is then positioned so that the adhesive layer 24 contacts the underside of adjacent tiles (such as larger square carpet tile 12 and carpet tile fraction 14) to span the adjacent edges of the tiles and thereby connect the tiles together to form a carpet tile installation. In this way, the tiles are assembled on a underlying flooring surface without the need to attach them to the floor surface, so that the tiles create a floor covering that “floats” on the underlying floor surface. Such a connector 20, for example, may be sized for use under some or all of the entirety of a carpet tile fraction (such as carpet tile fraction 14) and extending under one or more of the adjacent larger carpet tiles (such as larger square carpet tiles 12).

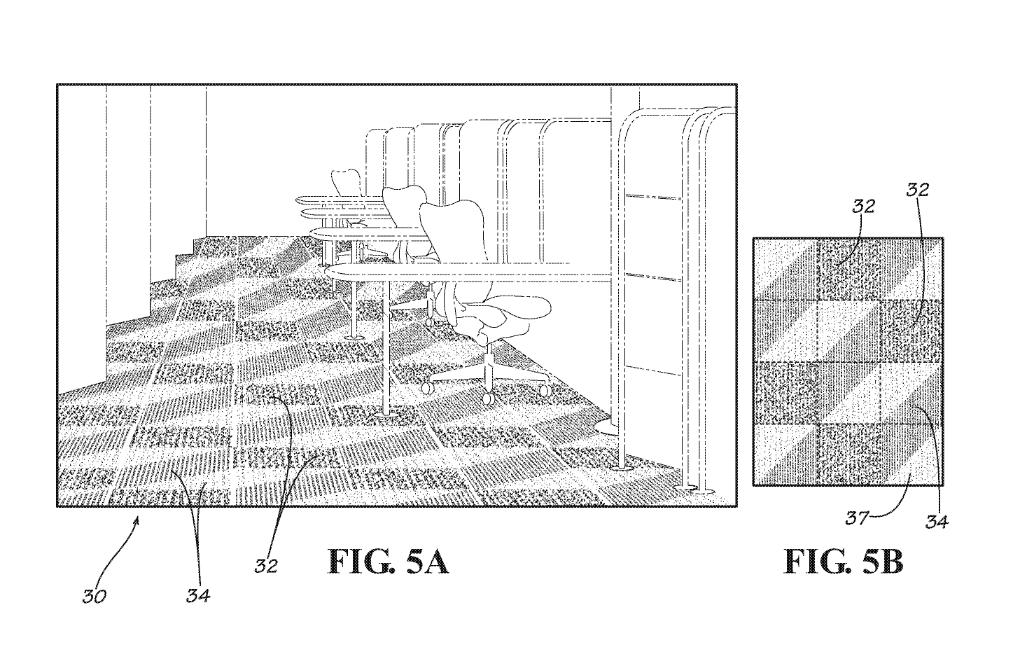

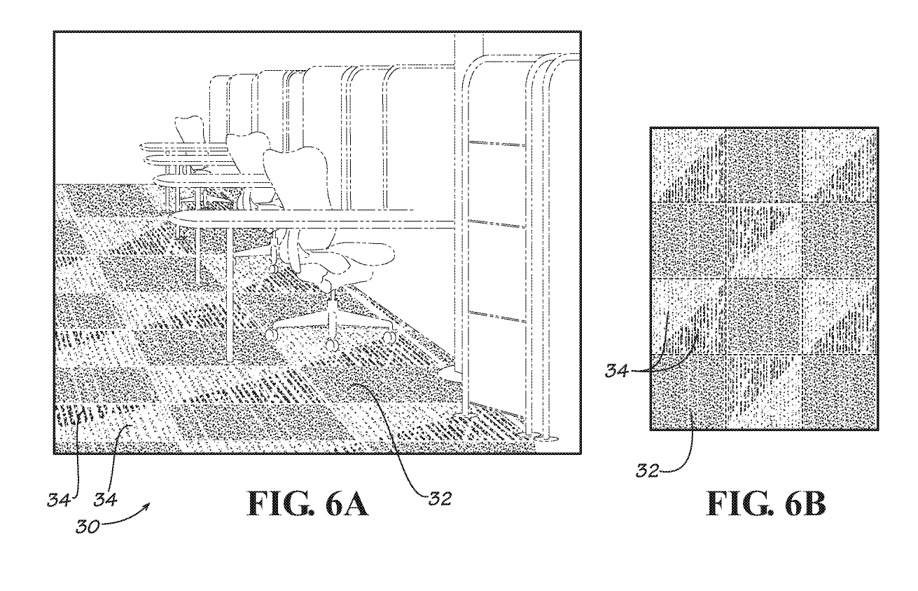

FIGS. 5A and 6A illustrate a carpet tile installation 30 according other embodiments of the invention. Carpet tile installation 30 is comprised of larger square carpet tiles 32 and carpet tile fractions 34 that together form an exemplary installation pattern (shown in FIG. 5B). In the embodiments shown in FIGS. 5A and 6A, carpet tile fractions 34 are carpet tiles of a triangular shape. The patterns shown in FIGS. 5B and 6B may be repeated to form the carpet tile installation 30. While these particular installation patterns provide various aesthetic and other benefits, other installation patterns may be used.

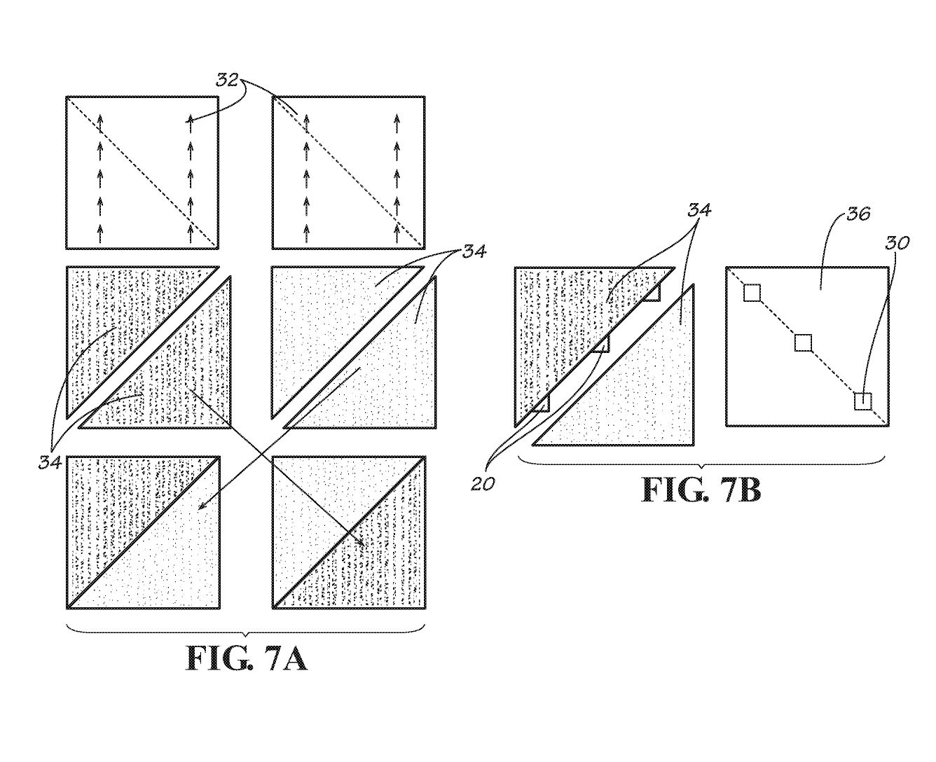

As shown in FIG. 7A, a larger square tile 32, such as a standard one-half square meter carpet tile, may be cut into carpet tile fractions 34, as shown in FIG. 7A. In other embodiments, carpet tile fractions 34 are cut directly from the carpet web without first being cut into the standard, larger square carpet tile 32. As shown in FIG. 7B, carpet tile fractions 34 then may be connected to one another using connectors 20 to form a combination carpet tile 36. These combination carpet tiles 36 may then be connected using connectors 20 to each other and/or to larger square, non-combination carpet tiles 32 in any number of patterns, such as the patterns of the carpet tile installations 30 shown in FIG. 5A or FIG. 6A.

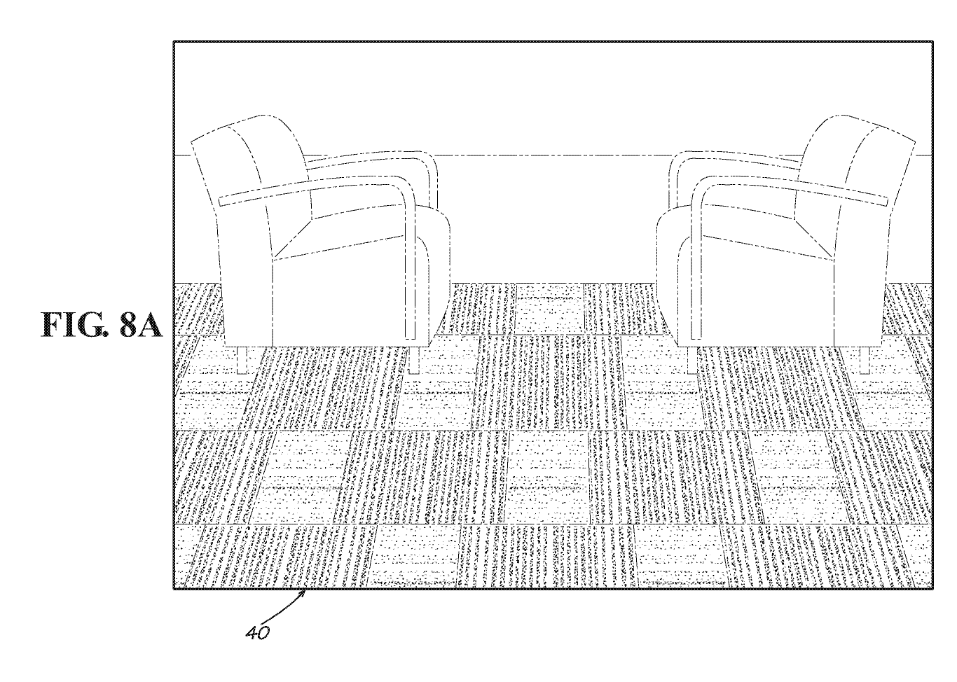

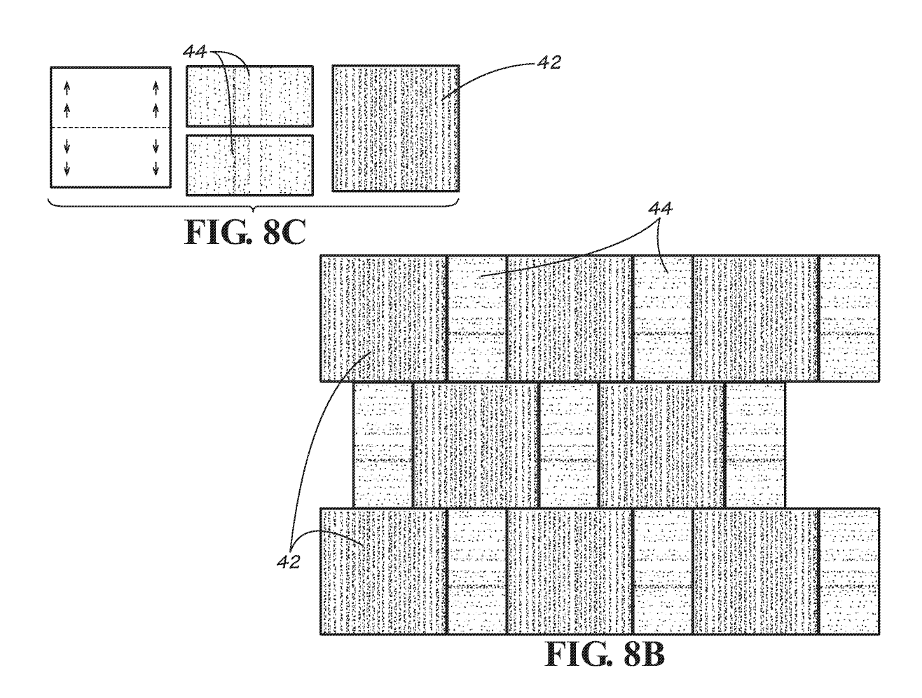

FIG. 8A illustrates a carpet tile installation 40 according to another embodiment of the invention. Carpet tile installation 40 is comprised of larger square carpet tiles 42 and carpet tile fractions 44 that together form an exemplary installation pattern. The pattern shown in FIG. 8B may be repeated to form the carpet tile installation 40 shown in FIG. 8A. While this particular installation pattern provides various aesthetic and other benefits, other installation patterns may be used.

As shown in FIG. 8C, a larger square tile, such as a standard one-half square meter carpet tile, may be cut into carpet tile fractions 44, as shown in FIG. 8C. In other embodiments, carpet tile fractions 44 are cut directly from the carpet web without first being cut into the standard, larger square carpet tile. Carpet tile fractions 44 may then be arranged in any number of patterns with larger square tiles 42 to form a carpet tile installation. In some embodiments, larger square carpet tiles 42 and carpet tile fractions 44 are connected using connectors 20.

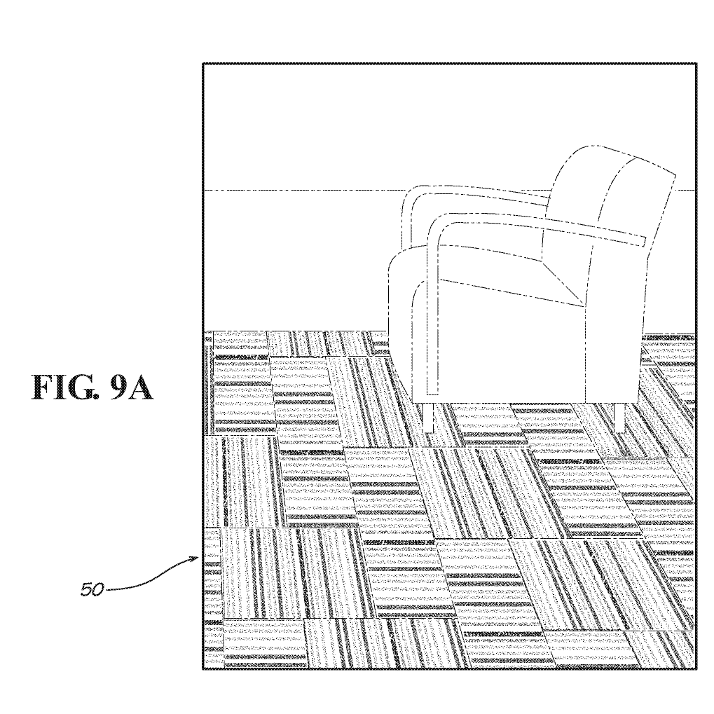

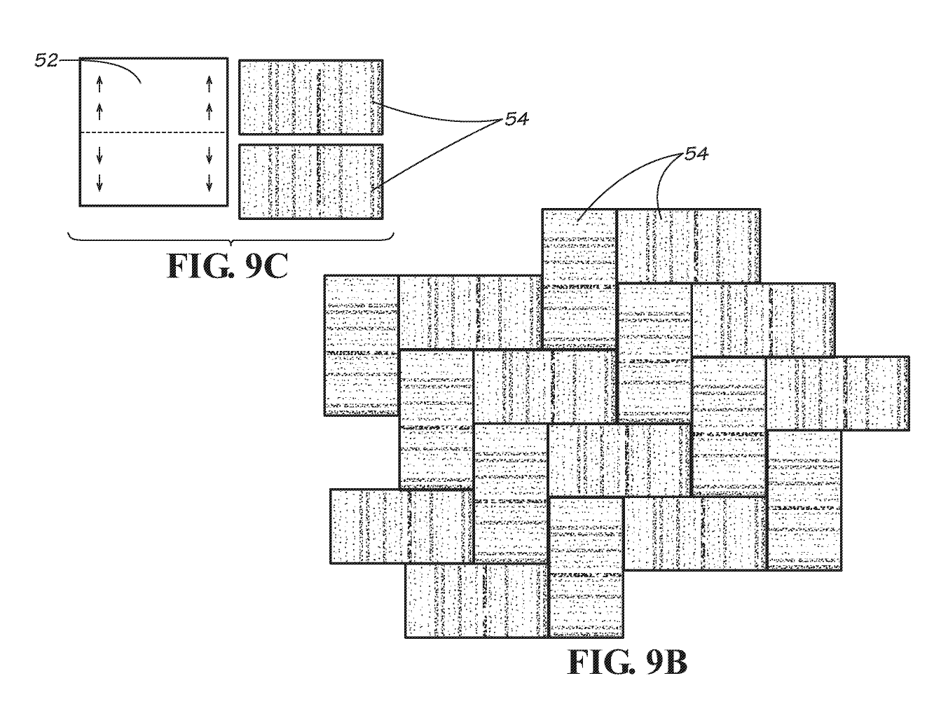

FIG. 9A illustrates a carpet tile installation 50 according to another embodiment of the invention. Carpet tile installation 50 is comprised of carpet tile fractions 54 that together form an exemplary installation pattern. The pattern shown in FIG. 9B may be repeated to form the carpet tile installation 50 shown in FIG. 9A. While this particular installation pattern provides various aesthetic and other benefits, other installation patterns may be used.

As shown in FIG. 9C, a larger square tile 52, such as a standard one-half square meter carpet tile, may be cut into carpet tile fractions 54. In other embodiments, carpet tile fractions 54 are cut directly from the carpet web without first being cut into the standard, larger square carpet tile 52. Carpet tile fractions 44 may then be arranged in any number of patterns to form a carpet tile installation. In some embodiments, the carpet tile fractions 44 are connected to one another using connectors 20.

Although the carpet tile fractions of this invention may be made from conventionally manufactured square tiles in any size and shape smaller than the starting square tiles, cutting schemes and installation patterns that utilize all parts of the originally square tile are the most economical in terms of tile cost, since they require the least number of square tiles. This invention includes, but is not limited to, embodiments that utilize the entire square tiles.

The carpet tile installations of FIGS. 1, 5A, 6A, 8A, and 9A may be made from carpet tiles having virtually any combination of tile colors and patterns. Particularly pleasing designs often use one color or style for all of the large tiles and a different color or style for all of the small tiles, and the pattern is visually most striking if there is significant contrast between the appearance of the small tiles as compared to the appearance of the large tiles. Particularly attractive version of this invention utilize relatively light colored large tiles and relatively dark small tiles.

Also disclosed is a method of installing different sized and/or shaped carpet tiles using one or more connectors 20. In one method of installing the different sized and/or shaped carpet tiles using the connectors 20, a first tile is placed on the floor at a position determined by conventional tile installation methods. A connector 20 is peeled from the release layer 26 (or from a stack of connectors 20) and positioned so that the adhesive layer 24 faces upward away from the underlying floor. The connector 20 is positioned so that only a portion of the adhesive layer 24 adheres to the underside of the tile, leaving the remainder of the connector 20 extending from the underside of the tile. A different sized and/or shaped tile or tiles are then positioned adjacent the first tile so that a portion of the connector 20 adheres to the adjacent tile(s). In this way, the connector spans the adjacent edge(s) of the adjacent tile(s).

These disclosed embodiments are merely illustrative. In short, the techniques and the other features described herein have uses in a variety of contexts, not to be limited by the specific illustrations provided herein. Embodiments may comprise different carpet tile shapes, colors, sizes, patterns, and other methods of producing and installing the carpet tiles and carpet tile installations than those disclosed herein may be utilized. The features shown are merely illustrative and are not intended to indicate that any component, feature, or method step is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

1. A floor covering comprising a plurality of carpet tiles cut from a carpet web,
wherein each of the plurality of carpet tiles comprises a textile face size and an underside,
wherein a first textile face size of a first set of the plurality of carpet tiles is smaller than a second textile face size of a second set of the plurality of carpet tiles,
wherein at least one of the carpet tiles of the first set is connected to at least one of the carpet tiles of the second set along the tiles' adjacent edges without attaching either of the carpet tiles to a floor surface on which the carpet tiles are positioned, each connector comprising:
a. a film configured to resist stretching; and
b. a layer of adhesive located on a side of the film, wherein the layer of adhesive is capable of forming a bond with the undersides of the carpet tiles so that, when the connector is positioned above the floor surface and spans the adjacent edges of the at least one of the carpet tiles of the first set and the at least one of the carpet tiles of the second set so that the layer of adhesive contacts the undersides of the tiles, the layer of adhesive prevents relative movement between the tiles, and the connector does not adhere to the floor surface.

2. The floor covering of claim 1, wherein the carpet tiles of the first set of the plurality of carpet tiles have a first shape that is different from a second shape of the carpet tiles of the second set of the plurality of carpet tiles.

3. The floor covering of claim 1, wherein the carpet tiles of the first set of the plurality of carpet tiles have a first shape that is substantially the same as a second shape of the carpet tiles of the second set of the plurality of carpet tiles.

4. The floor covering of claim 1, wherein the carpet tiles of the first set of the plurality of carpet tiles have a first pattern that is different from a second pattern of the carpet tiles of the second set of the plurality of carpet tiles.

5. The floor covering of claim 1, wherein the carpet tiles of the first set of the plurality of carpet tiles are cut from a larger carpet tile.

6. The floor covering of claim 1, wherein the carpet tiles of the first set of the plurality of the carpet tiles are cut directly from the carpet web.

7. The floor covering of claim 1, wherein the second textile face size of the carpet tiles of the second set are approximately one-half square meter.

8. The floor covering of claim 7, wherein the carpet tiles of the first set are cut from approximately one-half square meter carpet tiles.

9. The floor covering of claim 1, wherein at least one of the carpet tiles of the first set of the plurality of carpet tiles is connected to another one of the carpet tiles in the first set of the plurality of carpet tiles using at least one connector to form a combination carpet tile.

10. The floor covering of claim 9, wherein the at least one of the carpet tiles and the another one of the carpet tiles are triangular in shape.

11. The floor covering of claim 9, wherein the combination carpet tile comprises a substantially square shape.

12. The floor covering of claim 1, wherein the film of the connector is configured to resist stretching by comprising a material exhibiting a tensile strength between 160 and 270 MPa in at least one direction.

13. A method of installing different sized carpet tiles on a floor surface comprising:
providing a first set of carpet tiles of a first size, each of the carpet tiles of the first set comprising an underside;
providing a second set of carpet tiles of a second size, each of the carpet tiles of the second comprising an underside, wherein the first size is different from the second size;
providing a plurality of connectors, each comprising:
a film configured to resist stretching and a layer of adhesive located on a side of the film;
positioning at least one of the carpet tiles of the first set of carpet tiles and at least one of the carpet tiles of the second set of carpet tiles on the floor surface so that the tiles are adjacent to one another; and
connecting the at least one of the carpet tiles of the first set to the at least one of the carpet tiles of the second set without attaching the tiles to the floor surface so that the connector spans adjacent edges of the tiles and so that the layer of adhesive contacts the undersides of the adjacent tiles and prevents relative movement between the adjacent tiles,
wherein the connector does not adhere to the floor surface.

14. The method of claim 13, further comprising cutting both the first set of carpet tiles and the second set of carpet tiles directly from a carpet web.

15. The method of claim 13, wherein at least some of the carpet tiles in the first set of carpet tiles are cut from carpet tiles in the second set of carpet tiles.

16. The method of claim 13, wherein providing the second set of carpet tiles comprises providing approximately one-half square meter carpet tiles.

17. The method of claim 13, further comprising cutting the first set of carpet tiles from approximately one-half square meter carpet tiles.

18. The method of claim 13, further comprising connecting at least one of the carpet tiles in the first set to another one of the carpet tiles in the first set using at least one connector to form a combination carpet tile.

19. The method of claim 13, wherein the film of the connector is configured to resist stretching by comprising a material exhibiting a tensile strength between 160 and 270 MPa in at least one direction.

20. A method of cutting carpet tiles of different sizes comprising:
cutting a first set of carpet tiles of a first size from a carpet web, each of the carpet tiles of the first set comprising an underside;
cutting a second set of carpet tiles from at least some of the first set of carpet tiles, each of the carpet tiles of the second set comprising an underside;
providing a plurality of connectors, each comprising:
a film configured to resist stretching and a layer of adhesive located on a side of the film;
positioning at least one of the carpet tiles of the first set of carpet tiles and at least one of the carpet tiles of the second set of carpet tiles on the floor surface so that the tiles are adjacent to one another; and
connecting the at least one of the carpet tiles in the first set to the at least one of the carpet tiles in the second set without attaching the tiles to the floor surface so that the connector spans adjacent edges of the tiles and so that the layer of adhesive contacts the undersides of the adjacent tiles and prevents relative movement between the adjacent tiles,
wherein the connector does not adhere to the floor surface.
